(19) United States
(12) Patent Application Publication
(10) Pub. No.: US 2006/0142076 A1
(43) Pub. Date: Jun. 29, 2006

(54) Method and system for conducting card games

(75) Inventors: Rodney L. Willyard, Flower Mound, TX (US); Gary Muller, Plano, TX (US); Yuhua Li, Plano, TX (US); Keith Riggs, Frisco, TX (US)

Correspondence Address: THE CULBERTSON GROUP, P.C., 1114 LOST CREEK BLVD., SUITE 420, AUSTIN, TX, 78746, US

(73) Assignee: Multimedia Games, Inc.

(21) Appl. No.: 11/020,300

(22) Filed: Dec. 23, 2004

(51) Int. Cl. G06F 19/00; G06F 17/00

(52) U.S. Cl. 463/11

(57) ABSTRACT

A method, apparatus, and program product for awarding prizes in a networked gaming system based on a player's performance in a card game conducted through the network. One method includes collecting game play requests from a number of player stations into a first group of game play requests. The method also includes determining if the first group of game play requests meets a predefined condition for a first card game. In response to meeting the predefined condition for the first card game, the method includes conducting the first card game between the player stations from which the first group of game play requests were collected.

### TECHNICAL FIELD OF THE INVENTION

This invention relates to electronic gaming systems enabling players from many different gaming locations to participate in card games. More particularly, the invention is directed to apparatus, methods, and program products for awarding prizes in a networked gaming system based on a player's performance in a card game conducted through the network.

### BACKGROUND OF THE INVENTION

Gaming machines such as mechanical slot machines and even early video slot machines and video poker machines were stand alone gaming machines in which a result for a game play was determined at the gaming machine itself in some fashion. Commonly, the gaming machine produced some random result in response to a game play request at the gaming machine. This random result was mapped to some prize that would then be awarded to the player. Many mechanical and video slot machines and other gaming machines still produce or determine the result of a game play at the gaming machine itself.

Certain modern gaming systems include gaming machines or player stations that are connected through some communications link to some other system component that is responsible for determining or identifying game play results. That is, although the game play requests are entered at the player stations, those requests are communicated to some other system component which determines or identifies a result for each game play. For example, some modern video lottery systems employ a server that receives game play requests from different player stations and assigns a predetermined lottery record and associated result for each game play request. U.S. Pat. No. 6,733,385 describes one such “central determinant” lottery system. Certain modern bingo gaming systems also include player stations and a separate server for actually conducting the bingo games and identifying results for each play in such a bingo game. U.S. patent application publication No. 2004-0152499, describes such a networked bingo gaming system.

One problem with stand alone gaming machines is that it is difficult to provide the player with a sense that their actions or inputs have any influence on their results. Giving the player the sense that his or her inputs at the gaming machine can affect the result of play is even more difficult with central determinant video lottery games and networked bingo games. Many players prefer to have the sense of competition and excitement generated in live table games and other traditional casino games.

### SUMMARY OF THE INVENTION

The present invention provides apparatus, methods, and program products for awarding prizes in a networked gaming system based on a player's performance in a card game conducted through the network such as draw poker, stud poker, blackjack, or a similar type of card game. One method according to principles of the present invention includes collecting game play requests from a number of player stations into a first group of game play requests. The method also includes determining if the first group of game play requests meets a predefined condition for a first card game. In response to meeting the predefined condition for the first card game, the method includes conducting the first card game between the player stations from which the first group of game play requests were collected.

A system embodying the principles of the present invention includes a number of player stations and a central processing device in a network. Each of the player stations is capable of producing a respective game play request in response to a player input at the respective player station. The central processing device in the network communicates with each player station of the network to collect the respective game play requests from the player stations. The game play requests may be sorted into categories of game play requests for different types of card games and then small groups (game groups) of game play requests from each category are formed. A card game is then conducted for each game group.

The present invention also includes a program product stored on at least one storage medium. The program product includes a set of machine-readable instructions that are configured to carry out the methods described herein.

These and other advantages and features of the invention will be apparent from the following description of the preferred embodiments, considered along with the accompanying drawings.

### BRIEF DESCRIPTION OF THE DRAWINGS

FIG. 1 is a high level diagrammatic representation of a networked gaming system embodying the principles of the present invention.

FIG. 2 is a flow diagram illustrating a gaming method embodying principles of the present invention.

FIG. 3 is a flow diagram showing additional steps that may be associated with entering a game play request according to the present invention.

### DESCRIPTION OF PREFERRED EMBODIMENTS

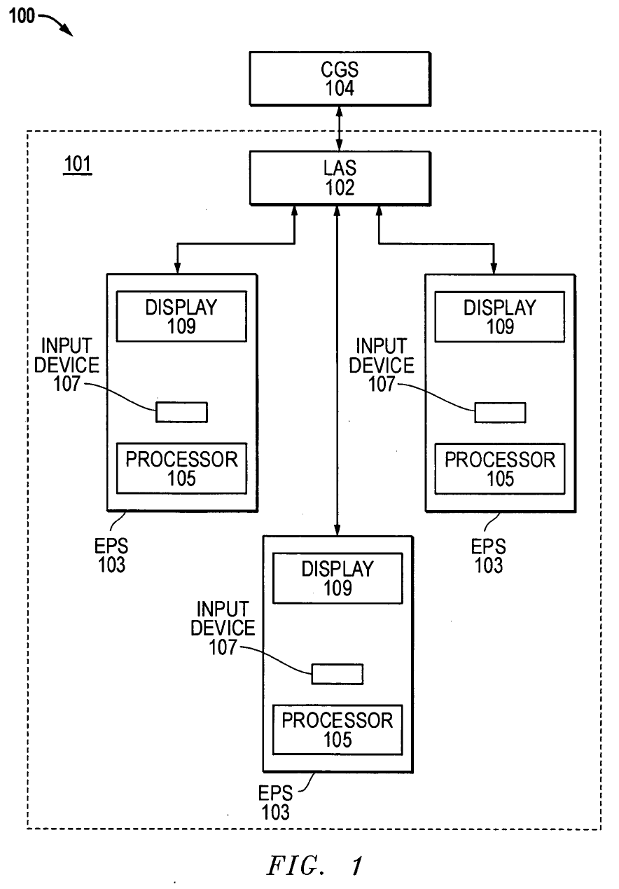

FIG. 1 shows a gaming system 100 that enables players to take part in either a single-player or a multi-player card game. Gaming system 100 includes one or more gaming sites or casinos 101. Each gaming site 101 may include a local area server (LAS) 102 and a number of electronic player stations (EPSs) 103. When multiple gaming sites 101 are included in the system 100, the system 100 may also include a central game server (CGS) 104 to allow system wide communications, data collection, and control between or among gaming sites 101.

In general, an EPS 103 includes a processor 105, an input device 107, and a display 109. As will be discussed in detail below, due to central control of card games in the system 100, a player at any EPS 103 in the system 100 may participate in a card game together with one or more other players at other EPSs 103 in the system. The card games that may be played in system 100 may be games such as draw poker, stud poker, other poker games, or blackjack, for example. The invention may be configured to support substantially any card game, and particularly any card game where the result of the game depends on a particular card hand achieved by the player and which can be evaluated against some standard or against another player's card hand.

It will be appreciated that FIG. 1 provides only a very diagrammatic representation of each EPS 103 and does not show many elements that may be included in such a player station. The additional details of an EPS 103 are unnecessary for a description of the present invention and are thus not shown in the figures. However, it will be appreciated that an EPS 103 preferably also includes volatile memory, nonvolatile memory, and network communications interface, all accessible by processor 105. The volatile and nonvolatile memory of an EPS 103 may store computer program code that may be executed by processor 105 to cause the processor to perform or direct the various functions provided by the respective EPS. The communications interface associated with a particular EPS 103 allows the EPS to send information such as a game play request to LAS 102 or CGS 104 and to received communications from these devices or other system components included in the gaming system network.

Although not shown in FIG. 1, it will also be appreciated that an EPS 103 may have a separate graphics processor controlled by processor 105 to cause various graphics to be displayed or presented on display 109. Furthermore, an EPS 103 may include more than a single display device. Display 109 may comprise multiple separate display devices such as CRTs, LCDs, plasma display devices, or any other suitable types or combination of display devices. In preferred EPSs 103 used in gaming system 100, one or more of the display devices making up display 109 may comprise a touch screen display device and thus the EPS may include one or more touch screen controllers operatively connected to processor 105 and the respective display devices. In addition, each EPS 103 will commonly include a sound system for providing high quality audio output at the EPS and a visual alerting device such as a light mounted at the top of the EPS.

Each EPS 103 may also include a device for receiving value and issuing value in the course of play. This device may accept currency, vouchers, or tokens, for example, and also output currency, vouchers, or tokens. Of course, any appropriate device for receiving and issuing value in games played according to the present invention may be used with an EPS 103, either incorporated into the EPS or separate from the EPS.

It should further be noted that the EPSs 103 need not be identical throughout system 100. Rather, there may be wide variations in the various components included in each respective EPS 103 depending upon the particular card games that are available at the respective EPS and depending upon any other factors.

Also, any suitable method and system of devices may be used for accounting for player wagers and winnings. The present invention of networked card gaming is not limited to any particular game accounting system. Preferred forms of gaming system 100 may use a game accounting system such as that set out in U.S. publication No. 2002-0132666 and entitled “Distributed Account Based Gaming System,” the entire content of which is hereby incorporated herein by this reference. To facilitate implementation of this account based game accounting system, an EPS 103 in system 100 may include a suitable card reader for reading information from a player account or player club card and/or a suitable interface such as an actual keypad or touchscreen keypad that allows a player to input player account or player identifying information.

Player account and player identification databases that may be used in system 100 to facilitate game accounting may be maintained at any suitable point in the system. In preferred implementations of system 100, the respective LAS 102 or a separate processing device associated with an LAS for a given gaming site or casino 101 maintains accounting and player databases for players using EPSs 103 at that particular gaming site or casino. However, a more centralized component, such as CGS 104 may also participate in maintaining player account and player activity information.

LAS 102 shown in FIG. 1 may comprise at least one computer system, and perhaps several separate computer systems each having one or more processors, nonvolatile memory, volatile memory, a user interface arrangement (for system operator access), and communications interface, all connected via one or more system busses. The volatile and nonvolatile memory may store computer program code that may be executed by the respective processor to cause the processor to perform or direct the various functions provided by LAS 102. A respective LAS 102 may serve as the central control for a card game in the system 100. For example, if players from different EPSs 103 have requested a draw poker game, the LAS 102 may group certain of the players when a predefined condition is met and may shuffle one or more decks of cards and deal a respective hand of cards from the deck or decks to each of the grouped players.

As referred to herein, the term “shuffle” refers to a process performed by a system component such as an LAS 102 to randomize the order of the cards that are to be dealt to the players in the course of a card game conducted through the system. The randomization may occur by randomizing a list of cards grouped into a file and dealing cards, or rather, “card representations” to a player sequentially from the file. Alternatively, the cards or card representations may be ordered in the file and randomly selected from the file for dealing to the different players. As used in this disclosure a “card representation” refers to any representation of a playing card, and may include a card code as described below or any other element used to represent a playing card.

As referred to herein, the term “deal” refers to a process performed by a system component such as a LAS 102 to communicate data to a player's EPS 103 to allow the EPS to display card representations at the display 109 of the respective EPS. Preferred forms of the present invention employ a system of playing card definitions that allows card definitions to be communicated from a LAS 102 or other system component to an EPS 103 using a minimal amount of data. Communicating minimal data to communicate card representations to an EPS 103 allows communication paths between the respective LAS 102 and the EPS to remain available for other communications that are required in a particular card game, and may also enable the EPS to operate more quickly to change graphics as required during the course of a card game.

In one preferred arrangement, a gaming system according to the present invention may define one or more decks of playing cards with a card deck file containing an entry for each respective card in the deck or decks. Each entry may contain a card definition code that represents the particular card which is the subject of the respective entry. In this arrangement an EPS 103 stores a database or file that correlates each card definition code used in the system with data that is required to direct the graphics related components of the EPS to actually produce a graphic representation of the particular playing card. The system device responsible for dictating the cards dealt to a given EPS 103, such as a LAS 102, simply communicates the card definition code to the EPS and the receiving EPS uses that code to access the graphics data to reproduce the intended playing card on the display 109 associated with the EPS. Of course, other variations for shuffling, dealing, and communicating card representations in system 100 are contemplated and would be apparent to those of ordinary skill in the art and viewing the present disclosure.

CGS 104 shown in FIG. 1 may comprise one or more computer systems each having one or more processors, nonvolatile memory, volatile memory, a user interface arrangement (for system operator access), and a communications interface, all connected to a system bus. These computer system details are omitted from the present drawings so as not to obscure the present invention in unnecessary detail. The processor or processors associated with CGS 104 preferably execute operational program code to allow the CGS 104 to perform the various functions that may be provided through the CGS in system 100.

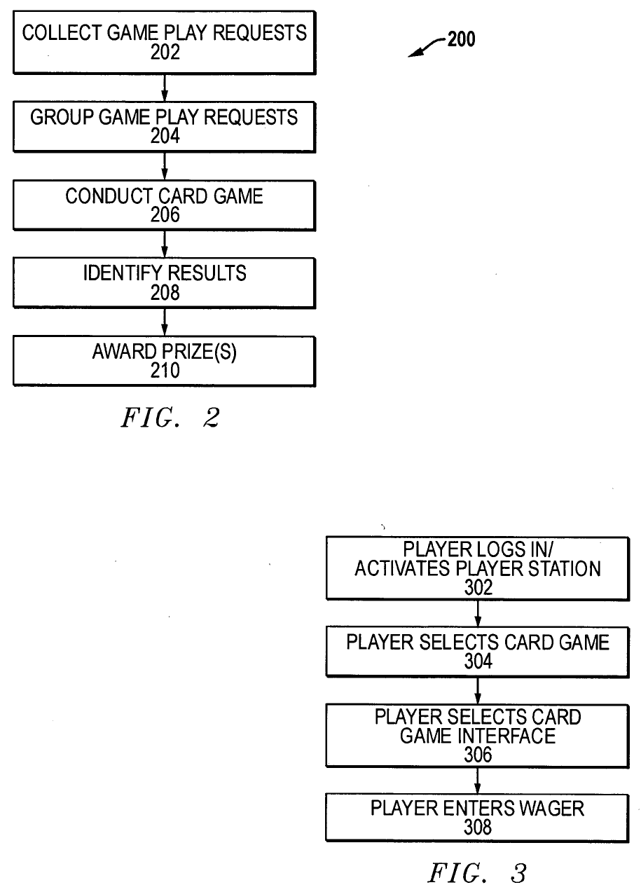

As will be described in further detail below in connection with FIG. 2, a player in system 100 generally requests to enter a card game by making a suitable input or set of inputs at an EPS 103. The appropriate input or inputs cause a game play request to be communicated from the EPS 103 to a central component in system 100 that conducts a card game for the game play request. Preferred forms of the invention group the game play requests and conduct a respective card game between the players associated with the grouped game play requests. In one form of gaming system 100, the game play requests from various EPSs 103 in the system are communicated ultimately to a central component such as CGS 104 which serves both as a game play request grouping component (or grouping component) for grouping game play requests and card game conducting component for conducting the various card games. Where the CGS 104 groups game play requests and conducts card games, each LAS 102 may operate to relay game play requests from its respective EPSs 103 to CGS 104 and to relay game conduct-related communications from the CGS back to the EPSs. In this preferred implementation of system 100, each LAS 102 may also be responsible for game accounting and player tracking tasks for its respective EPSs 103. The nature of these accounting and player tracking tasks will depend upon the particular game accounting and player tracking systems that might be used in system 100. Since the present invention is not limited to any particular game accounting and player tracking systems, details of such systems are omitted from this disclosure.

According to the present invention, the identification of a player's result for a given card game may be performed at each respective EPS 103 involved in the card game or may be performed by a system component separate from the respective EPS such as CGS 104. Preferred forms of the invention implement an evaluation component at the same system component that serves as the game play request grouping component and game conducting component. This evaluation component serves to identify a result for a given player in a given card game. In other embodiments, a respective EPS 103 may cooperate with a central component such as CGS 104 to serve as the evaluation component or game result identifying component for the EPS.

A separate prize awarding component of system 100 may be responsible for awarding prizes to players in a given card game after the results of the card game have been identified for each player. This prize awarding component may be associated with a central component of system 100 such as a LAS 102 or CGS 104, or a separate such component may be associated with each EPS 103 depending upon the prize awarding rules implemented in a given system 100. Further description of prize awarding processes that may be used in a system such as system 100 will be described below with reference to FIG. 2.

Regardless of the various system tasks performed in normal operation by each LAS 102 and CGS 104, each or these elements may be programmed to take over the functions of the other in certain circumstances. For example, as will be discussed in further detail below, CGS 104 may be configured in the normal operation of system 100 to collect game play requests from players at various gaming sites 101, sort and group the game play requests, and conduct a respective card game for each game group. In this example, a LAS 102 may perform the functions of collecting game play requests into groups and conducting the desired card game for each group rather than having CGS 104 perform these tasks. Switching the game play request grouping and game conducting functions to the respective LAS 102 may be desirable where the LAS 102 serves a large number of EPSs 103 and during a time of high player activity, or in the event the communications link between the respective LAS 102 and CGS 104 is severed or degraded below a certain level.

It will be appreciated that the particular configuration of devices shown in FIG. 1 is shown only for purposes of example. A gaming system according to the present invention may omit some or all of the separate LASs 102 at the various gaming sites 101 so that the EPSs 103 communicate directly with CGS 104. Also, various regions or different gaming sites 101 may be divided up into separate systems each having a respective CGS such as CGS 104. A system according to the invention may also be configured such that any one of several different CGSs 104 could service a given EPS 103 anywhere in the system.

It will also be appreciated that the various components described above are implemented at a LAS 102, CGS 104, or EPS 103 through operational computer program code executed by one or more processing devices. For example, the grouping component and game conducting component may be implemented through computer program code executed at CGS 104 or a LAS 102. The evaluation component is also preferably implemented through computer program code executed at a central system component such as CGS 104 or a LAS 102.

FIG. 2 is a flow diagram illustrating a gaming method 200 that may be performed through system 100 of FIG. 1. In general, players may use the EPSs 103 included in system 100 to enter game play requests. These game play requests are collected at process block 202. At process block 204, the game play requests are segregated or grouped into categories and then into specific game groups. Ultimately, a card game is conducted for each collected game group as indicated at block 206. The result of each card game for each player is identified as indicated at block 208 in FIG. 2, and prizes are awarded to the various players according to the identified results as shown at process block 210.

A player at a respective EPS 103 in system 100 shown in FIG. 1 may enter a respective game play request using the input device 107 and/or other input devices or arrangements included with the EPS (such as display 109 where the display includes a touch screen display device). The specific steps that may be required to enter a game play request at an EPS 103 may vary widely within the scope of the invention. In one preferred form of the invention, the player, after any required login at the EPS 103, may simply be required to enter a bet or wager amount and press a “PLAY” button associated with input device 107 or a touch screen. In other forms of the invention, the player may also be required to select a particular type or style of card game through the EPS player interface including input device 107 and display 109 or make other selections. Further options associated with entering a game play request will be discussed below with reference to FIG. 3.

Regardless of the specific steps that may be required of a player in system 100 to enter a game play request through their EPS 103, the game play request communicated to the grouping component (such as CGS 104 of an LAS 102) preferably includes an identifier which directly or indirectly identifies the type of card game to be played, and an identifier for the EPS 103 from which the game play request originates. In some forms of the invention, an EPS 103 may be dedicated to a particular card game so that any game play request identifying that EPS indirectly also identifies the card game for the game play request. Other forms of the invention may include as part of a game play request wager information, various player preference information or a player identifier that can be used to look up player preference information from a player tracking component of system 100, and/or information on a character that may represent the player in the course of play as will be discussed below with reference to FIG. 3. All game play requests, or at least a portion of each request or a surrogate for each request is collected at the grouping component as indicated at block 202 in FIG. 2.

At process block 204, the grouping component in the particular implementation (CGS 104 or an LAS 102) groups the collected game play requests in order to form different game groups, each for a separate card game. This game group formation preferably includes first grouping or segregating collected game play requests into different categories and then forming game groups from within the various collection categories. The grouping or segregation into categories may be accomplished by considering any of a number of different parameters or characteristics that may be associated with the collected game play requests. The invention is not limited to any particular parameters or characteristics that may be used for game play request grouping or segregation. In one preferred form of the invention, the incoming game play requests are simply grouped or segregated by the type of card game associated with each request. For example, all game play requests for a 5-card draw poker game may be segregated into one category, while requests for a 7-card stud poker game may be segregated into another category, and requests for a “high-low Chicago” poker game may be segregated into another category and so forth for each specific type of card game. In addition to grouping according to the card game, the grouping could be based on the number of game play requests that have been entered for the card game. Still further, the grouping could be performed by the amount that a player bets in the card game or by a bet range that will be adhered to over the course of the desired card game.

Players may also be grouped according to skill levels in the card game that they request. The skill level for a player may be found from determinants such as the number of wins the player has accumulated in the card game over time. In other embodiments, although not as accurate for measuring skill level, player skill level may be measured according to the number of times the player has entered a given card game.

Regardless of the particular parameters used to group or segregate game play requests into different categories, the grouping performed in the present invention may be accomplished according to the grouping method described in U.S. patent application Ser. No. 10/752,293, entitled “Method, System, and Program Product for Grouping Game Players by Class.” The entire content of this prior application is hereby incorporated in this disclosure by this reference.

In preferred forms of the invention, each game group must meet some predefined condition or set of conditions before a card game may be conducted for that game group. One predefined condition that may be used is the number of game play requests to be included in a game group. For example, game groups may be formed with just two game play requests so that the players play the requested card game one-on-one. Alternatively, a range of game play requests to be included in a given game group may be used either alone or in connection with some time constraint. For example, the grouping component (CGS 104 or an LAS 102) may implement the rule that game groups may include between 2 and 5 game play requests that have been grouped within two seconds of the first game play request being allotted to the particular game group. Some preferred forms of the invention limit the number of game play requests to be included in a given game group in order to limit the amount of time necessary to form a game group. This limiting of game play requests per game group may limit the time delay between the time a player enters a game play request through their EPS 103 and the time that the game for that game play request begins. In any event, the number of game play requests required to begin a card game with a given game group may be referred to as a “quorum.”

In general, as illustrated at process block 206, when the system 100 (shown in FIG. 1) determines that a game group meets a predefined condition for conducting a card game, the system 100 may begin conducting a card game for the game group. Before describing the various manners in which card games may be conducted according to the present invention it should be noted that preferred forms of the present invention do not conduct card games sequentially. Rather, a requested card game is conducted immediately upon the formation of the given game group. Thus, the step of conducting a card game as shown at process block 206 in FIG. 2 is actually performed in multiple instances simultaneously. That is, a gaming system such as system 100 shown in FIG. 1 may, at any point in time, have numerous card games in progress and in various stages of completion. In a large system in which a centralized component such as CGS 104 groups game play requests and conducts games for several gaming sites, each having a large number of EPSs 103, the system may have hundreds or thousands of card games in the course of being conducted at any given time.

The game conducting component of a gaming system according to the present invention (such as CGS 104 or an LAS 102 in FIG. 1) conducts a respective card game by performing or administering a number of different steps appropriate for the respective card game being played. In substantially every case, the game conducting component first deals a hand of card representations to each of the players in the defined game group. That is, the game conducting component electronically deals a hand of cards to each EPS 103 from which a game play request included in the game group was received. The initial deal may include dealing a certain number of community cards for some types of card games that may be conducted according to the invention. Once the initial deal is performed, there may or may not be additional steps that must be performed in order to complete the respective game. In straight 5-card poker, for example, there may be no additional steps required to conduct the game and the process may simply proceed to identifying results for each player as indicated at block 208 in FIG. 2 and awarding any prizes that have been won as shown at block 210. For other games, such as 5-card draw poker, for example, conducting the game requires enabling players to discard certain cards in their initial hand. Also, players may be allowed to make an additional bet or wager after the initial hand is dealt, and again after receiving their respective additional cards. The various actions or inputs required by the players in this example may be required in sequence from some starting point among the players as in a live poker game with each player receiving information on or “seeing” what the other players have done. Alternatively the game rules may require having the various players in the game make their bets and other inputs without the benefit of knowing what the other players for the game group have done. Other actions that may be performed by a player in the game include passing a bet, holding their initial cards, and calling a bet, for example. In any event, any required inputs by the players are entered through the input device 107 or other input arrangement (such as a touch screen display) at their respective EPS 103. Also, to the extent the players in a game receive information on the actions taken by the other players in the game group, this information is preferably displayed in some suitable form on the display 109 associated with the player's EPS 103.

It will be appreciated that the present invention is not limited to any particular rules of play for a given card game. In draw type poker games for example, there may or may not be limitations on the number of cards held or discarded. The invention encompasses substantially any rules by which card games may be conducted.

As mentioned above, dealing a card according to the present invention involves identifying a card from a card deck or decks and the communicating that card or the identity of that card to the respective EPS 103 or EPSs that must display the dealt card to the player according to the game rules and the player interface for the game. In embodiments where players are able to view only their own cards at their player station, a card or card identity for each card for a given player's hand must only be communicated to a single player station (EPS 103 in FIG. 1). Ultimately, such as when a bet is called, a player at a given player station is preferably allowed to see not only their own card hand, but the various competitors' hands as well. Thus, at this stage of a game, the player station must not only receive identifying information to display the player's cards but also identifying information to display the competitor's cards.

It will be noted that even where a player can see their own hand or cards, they may not be able to see the face of each of their own cards all at once because one or more cards may be dealt face down. Where a card is dealt face down or face away from a given player, the communication of the card identity need not be made until the face of the card is actually required to be shown at the respective player station. That is, a standard card back graphic may be stored at an EPS 103 and displayed for each face down or face away card visible to a player at the player station. The actual identity of the card, that is, the identity of the card face, is only required at a given EPS 103 in FIG. 1 when the card face must be displayed to the player in the play of the game. Thus, it is possible in some implementations of the present invention that a hand dealt to a player/EPS 103 does not include the identity of each card in a single communication. The identity of each card face dealt to a player/EPS 103 may be delayed until the identity is actually needed at the EPS to show the card face. However, some preferred forms of the invention use the game conducting component such as CGS 104 or a LAS 102 to communicate to the respective EPS 103 the identity of all cards dealt to the player/EPS regardless of whether some cards are dealt to the player/EPS face down.

As discussed above in connection with the functions of the game conducting component of gaming system 100 in FIG. 1, the communications required to conduct games according to the invention preferably include only the minimal possible amount of data. Thus, the step of communicating a card hand to a player/EPS 103 in the course of conducting a card game as indicated at block 206 in FIG. 2 includes communicating only identifiers for each respective card in the hand. The EPS 103 is then preferably responsible for looking up the graphics data required to define graphic elements and direct graphic generating components of the EPS to actually produce the graphic representation of a respective card.

The invention encompasses any suitable arrangement by which the game conducting component can keep track of the various cards dealt and held by a player in a card game. In one preferred form of the invention, the game conducting component creates a game play table for each game it conducts. Such a game play table may include a separate entry for each player in the game. Each table entry may include an identity of each card dealt to the player, each card discarded, and any other information required to identify a hand held by the respective player. Alternative player hand tracking arrangements may maintain a separate table or file for each hand. Each respective table or file in this hand tracking arrangement includes the identity of each card dealt to the player, each card discarded, and any other information required to identify a hand held by the respective player.

When a card game is completed by the game conducting component, either CGS 104 or a LAS 102 in FIG. 1, one or more evaluation components in the system evaluates each player's hand as it stands at the completion of the game. This player hand evaluation is used to identify a result for each player according to the step shown at block 208 in FIG. 2. In one preferred form of the invention, the evaluation component is implemented at the same processing system used to implement the game conducting component. The evaluation is performed at this centralized component such as CGS 104 or a LAS 102 by analyzing the current hand for each player using the player hand data maintained by the game conducting component. For example, for 5-card draw poker, the evaluation component identifies the final hand of cards achieved by a respective player and identifies the best poker hand produced by that final hand preferably according to the standard hierarchy of poker hands.

Although the evaluation component is preferably implemented at the same centralized system element used to implement the game conducting component, it will be appreciated that the evaluation component may be implemented at each EPS 103 for evaluating that player's hand in the given game. The evaluation would be conducted by identifying the final hand of cards achieved by the player at that EPS 103 and identifying the best poker hand produced by that final hand preferably according to the standard hierarchy of poker hands. Depending upon how prizes are awarded in the networked card gaming system according to the invention, the poker hand value identified by an evaluation component at a respective EPS 103 may need to be communicated to a centralized component which then uses that information to identify a result for each player in the game and potentially award prizes.

The invention encompasses numerous different arrangements or sets of rules for awarding prizes as shown at process block 210 in FIG. 2. For example, an award for each player may be based on a pay table that correlates the hierarchical value of a player's final card hand, to an award or prize level. The prize awarding component awards a prize to each player in the game according to the prize amount to which the player's hand value correlates. Alternatively, the card hand of each player in a given card game may be compared against the card hand of each other player in the game to find the hand having the greatest value among the various players. The prize awarding component of the gaming system awards a prize to the player achieving that highest value hand in the game and the prize may be based on bets that the player placed during the game and/or on bets placed by the other players during the course of the game. Further, a combination of comparing player hands and identifying a prize from a pay table may be used for awarding prizes through a suitable prize awarding component. For example, the player with the best hand for a given card game conducted according to the invention may be found and then the prize for that player's hand may be determined from a pay table correlating hierarchical hand values with award values, while other players would not be awarded any prize at all or some consolation prize that may be taken from a consolation prize table. This consolation prize table may correlate hierarchical card hand values with consolation prize levels.

As discussed above, the present invention is not limited to any particular system of accounting for wagers and winnings. Thus, prizes may be awarded to a player in any suitable fashion. For example, a prize or award may be credited to a player account in an account based accounting system. Awards may also be dispensed at an EPS 103 as vouchers, coupons, tokens, or currency for example.

Upon completion of a card game among players, the players may then be prompted as to whether they choose to enter another card game and play continues as described herein. It will be appreciated that the game may be a draw poker game, a stud poker game, a blackjack game, or other type of card game.

The above description of the networked card gaming system according to the present invention focuses on multi-player card games in which players at different EPSs 103 in system 100 in FIG. 1 play card games against each other or at least participate jointly in card games. In other embodiments of the invention, the card game may be conducted for just one player either in an effort to produce the best card hand alone or in an effort to produce a better card hand than an automated house or dealer, or some number of automated players. Essentially the same options are available for this single-player implementation of the invention as described above the multi-player versions, except that a system component may “play” the automated player hands or a dealer hand that may be included in a given card game.

FIG. 3 illustrates a method that may be used to enter game play requests to be collected at block 202 in FIG. 2. As shown at block 302 in FIG. 3, a player first takes any necessary player login or other activating action at their respective player station such as EPS 103 in FIG. 1. Once this initial EPS login/activation step is taken, the player selects the card game they wish to play as shown at process block 304. At process block 306, a player selects a card game interface and at process block 308 enters a wager for the game. This last selection or perhaps a separate “PLAY” entry at the EPS 103, preferably causes the EPS to communicate the game play request to the collecting and grouping component included in the system, such as CGS 104 or a LAS 102 shown in FIG. 1. It will be appreciated that each of the selections shown in FIG. 3 are entered by the player at a suitable player interface arrangement associated with their EPS 103, such as input device 107 or display 109 where the display includes a touch screen display device.

The card game interface that a player selects at process block 306 may be a custom interface that may include aesthetic properties of the graphic display a player views during the game such as color of the display or design on the cards in the display. In other cases, the card game interface that the player selects at process block 306 in FIG. 3 may affect the display presented to another player in a card game. For example, a player may either choose to have a representation of themselves appear to other players in a card game or choose to have representations of other players appear on the player's EPS 103. The representation of each player displayed at an EPS 103 may be from a live video feed to the respective player. The live video feed may be through a video camera such as a web cam associated with the player's respective EPS 103.

In other embodiments, a player may be offered to choose an animated character to represent themselves in the game. For example, potential characters for a player to select to represent themselves could include animated human characters having various “personalities” that react in certain predictable ways to various situations. There is essentially no limit to the types of personalities or the graphic appearance of animated human characters that may be selected. Further, characters to choose from could be from non-human categories such as space aliens, super heroes, animals, and so forth. Still further, characters to choose from could be famous people, cartoon characters, and so forth, each with their own personality.

In another embodiment, players may be allowed to generate their own custom character personalities to respond to card hands that are received during the card game. The player may choose characteristics that the player believes will adequately bluff other players and allow the player to maximize their betting success during the card games. To avoid processing delays, these custom character personalities and associated graphics are generated from program code stored at the EPS 103 that is to present the representative character. The selection of a particular representative character to show other players in a game, whether custom or predefined, may be communicated to the game play request collecting and grouping component in the gaming system, such as CGS 104 or a LAS 102, and this component may communicate the selection information to other EPSs 103 that are implicated in the given game group. The various EPSs 103 implicated in the given game group may then use the character selection information to generate a graphic display for the character representing each other player in the game group. Thus, the player at the player station is able to see in their respective player station display not only a graphic representation of their own hand of cards, but also the other players in the game that appear to play the given card game along with the player at the player station.

In yet another embodiment, rather than choosing a character to represent themselves, the game interface selection at block 306 in FIG. 3 may allow a player to choose the appearance of their competitors. This embodiment is particularly useful when the card game is a single player game where the player may be matched against a computer system such as an EPS 103 of FIG. 1.

Numerous variations for the play in the card games may be possible, either for multiple or for single player games. The processing device for the card games, for example LAS 102 or CGS 104 (both of FIG. 1), may also perform the processing for the character personalities, if necessary, as well as the processing for grouping the player game play requests in preparation for a card game between the players. However, it will be appreciated that, similar to card representation processing, in order to have the animated characters appear to make timely moves during the card game, processing for a graphically intensive character such as some of the above described characters may require the character processing to occur at the EPS 103, rather than performing the character processing at a central processing device and communicating the character graphics across a network to the EPS 103. When the animation processing occurs at the EPS 103, minimal data need be transmitted to the EPS 103 from the central processing device.

Although FIG. 3 shows game selection, game interface selection, and wager selection at a player station such as EPS 103 in FIG. 1, it will be appreciated that all three of these steps are not required according to the invention. For example, a game available at an EPS 103 in FIG. 1 may be fixed so that only the game interface and wager may be selected. In other cases, the game interface is fixed and the player may only select a type of game and a wager. The invention encompasses each of these steps individually or any combination of these steps.

As will become apparent to one of ordinary skill in the art and viewing the disclosed embodiments, further variations for prize mapping and distribution are possible and are within the scope of the appended claims. The above described preferred embodiments are intended to illustrate the principles of the invention, but not to limit the scope of the invention. Various other embodiments and modifications to these preferred embodiments may be made by those skilled in the art without departing from the scope of the invention.

1. A method including:
(a) collecting game play requests from two or more player stations into a first group of game play requests, the two or more player stations being included in a larger number of player stations;
(b) determining if the first group of game play requests meets a predefined condition for a first card game; and
(c) in response to meeting the predefined condition for the first card game, conducting the first card game between the player stations from which the first group of game play requests were collected.

2. The method of claim 1 further including collecting additional game play requests from two or more additional player stations into a second group of game play requests while conducting the first card game, the two or more additional player stations being included in the larger number of player stations.

3. The method of claim 1 further including displaying a respective random set of cards at each of the player stations from which the first group of game play requests were collected.

4. The method of claim 3 further including evaluating each random set of cards to determine the player station with a winning set of cards.

5. The method of claim 3 wherein the respective random set of cards at one of the player stations is modified in response to a player input at the player station.

6. The method of claim 5 wherein the respective random set of cards at the one player station is modified by one or more replacement cards, each replacement card replacing one of the cards in the respective random set of cards at the one player station.

7. The method of claim 4 wherein the winning set of cards comprises a respective set of cards that makes a highest value poker hand relative to the other sets of cards.

8. The method of claim 1 wherein the player stations from which the first group of game play requests were collected include a first player station at which a first player is located and a second player station at which a second player is playing, and the step of conducting the first card game includes displaying a representation of the first player at the second station and displaying a representation of the second player at the first player station.

9. A system for conducting card games, the system including:
(a) a number of player stations, each player station for producing a respective game play request in response to a player input at the respective player station; and
(b) a processing device in communication with each player station, the processing device for collecting the respective game play requests from the player stations into two or more game groups of game play requests and for conducting a card game for each game group.

10. The system of claim 9 wherein the processing device is also for conducting a first card game for a first game group over a common period of time with a second card game for a second game group.

11. The system of claim 9 further including a game conducting component at the processing device to conduct the respective card game for each game group.

12. The system of claim 9 further including an evaluation component to evaluate each hand of cards in the respective card game.

13. The system of claim 9 further including a display at each of the player stations to display a player's respective hand of cards.

14. The system of claim 13 wherein the display at each respective player station associated with one of the at least two game groups displays at least a portion of a card hand for each other player associated with the respective game group.

15. The system of claim 13 wherein one of the at least two game groups is associated with a first one of the player stations at which a first player is located and a second one of the player stations at which a second player is located, and wherein the display of the first one of the player stations displays a representation of the second player and the display of the second one of the player stations displays a representation of the first player.

16. The system of claim 15 wherein the representation of the first player displayed at the second one of the player stations comprises an animated character and wherein the second one of the player stations includes a graphics processing arrangement for directing the respective display to produce the animated character based on character behavior and visual characteristic data stored at the second one of the player stations.

17. A program product having at least one storage medium for storing a set of machine-readable instructions that when executed are configured to:
(a) collect game play requests from two or more player stations into a first group of game play requests, the two or more player stations being included in a larger number of player stations;
(b) determine if the first group of game play requests meets a predefined condition for a first card game; and
(c) in response to meeting the predefined condition for the first card game, conduct the first card game between the player stations from which the first group of game play requests were collected.

18. The program product of claim 17 wherein the set of machine-readable instructions further includes machine-readable instructions that when executed are configured to display a respective hand of cards at each of the player stations from which the first group of game play requests were collected.

19. The program product of claim 17 wherein the set of machine-readable instructions configured to determine if the first group of game play requests meets the predefined condition for the first card game includes machine-readable instructions that when executed are configured to compare a number of the collected game play requests to a predefined number to determine when a quorum of the game play requests have been collected.

20. The program product of claim 17 wherein the set of machine-readable instructions configured to conduct the first card game between the player stations further includes machine-readable instructions that when executed are configured to allow a player to select a custom interface for the first card game.
